(19) United States
(12) Patent Application Publication
(10) Pub. No.: US 2002/0136902 A1
(43) Pub. Date: Sep. 26, 2002

(54) Annealable imaging support

(76) Inventors: Dennis J. Eichorst, Lenexa, KS (US); Charles L. Bauer, Webster, NY (US); Brian K. Brady, North Chili, NY (US)

Correspondence Address: Sarah Meeks Roberts, Patent Legal Staff, Eastman Kodak Company, 343 State Street, Rochester, NY, 14650-2201, US

(21) Appl. No.: 09/751,114

(22) Filed: Dec. 29, 2000

(51) Int. Cl. B32B 27/00; B32B 27/40

(52) U.S. Cl. 428/423.7; 428/458; 428/481

(57) ABSTRACT

An imaging support comprising: a polyester base having two sides; and an electrically conductive layer superposed on one side of the base, wherein the electrically conductive layer comprises electrically conductive metal-containing fine particles dispersed in a blend of a polyurethane binder and a hydrophilic cobinder; wherein the polyurethane binder is an aliphatic, anionic polyurethane having an ultimate elongation to break of at least 350 percent.

### CROSS REFERENCE TO RELATED APPLICATIONS

This application relates to commonly assigned copending application Serial No. ______, ANNEALABLE IMAGING SUPPORT CONTAINING AN ANTISTATIC LAYER filed simultaneously herewith. This application relates to commonly assigned copending application Ser. No. ______, AMINE MODIFIED GELATIN LAYER FOR IMPROVED ADHESION OF PHOTOGRAPHIC ELEMENTS AFTER ANNEALING filed simultaneously herewith. This application relates to commonly assigned copending application Ser. No. ______, FILM SUPPORT WITH IMPROVED ADHESION UPON ANNEALING filed simultaneously herewith. This application relates to commonly assigned copending application Ser. No. ______, FILM SUPPORT WITH ANNEALABLE LAYER AND IMPROVED ADHESION filed simultaneously herewith.

### FIELD OF THE INVENTION

The present invention relates to light sensitive imaging elements in general and in particular to film supports whose ability to adhere to other layers is improved upon annealing.

### BACKGROUND OF THE INVENTION

In photographic film manufacture, an imaging layer which typically consists of silver halide grains dispersed in gelatin is deposited onto a polymeric film support which provides support and mechanical integrity to the final product. Cellulosic or polyester supports, such as poly(ethylene terephthalate) (PET) and poly(ethylene naphthalate)(PEN), are typically employed. Polyester supports are considered to be advantageous to cellulose triacetate supports for many imaging applications because they have excellent mechanical strength, dimensional stability and resistance to attack by many chemicals. Furthermore, polyester supports can be manufactured efficiently and at a reduced cost compared to cellulose triacetate supports. However, the chemical inertness of polyester supports also results in difficulty in obtaining acceptable adhesion of polar materials, such as gelatin-based photographic emulsions, to PET and PEN substrates.

To obtain acceptable adhesion of a silver-halide emulsion layer or a backing layer to a polyester support a variety of methods have been used including, surface treatment of the support or application of adhesion promoting or subbing layers either prior to orientation and crystallization of the support or post-orientation. Adhesion of the anchoring, or subbing layer is promoted by a variety of methods, including the use of chlorine-containing copolymers, as described in U.S. Pat. Nos. 2,627,088; and 3,143,421. The application of the adhesive layer prior to the orientation and heat setting or crystallization of the polyester, and the addition of organic solvents which attack the polyester film surface is described in U.S. Pat. No. 3,501,301. In addition, a subsequent gelatin-containing layer is often required on the emulsion side of the support, prior to photographic emulsion coating, for adequate adhesion.

Similarly, surface treatment or a subbing system is used on the back side of a polyester support, to promote adhesion of electrically-conductive antistatic layers, abrasion resistant layers, magnetic layers, anti-halation layers, curl-control layers, lubricant layers, or other auxiliary layers. A particularly effective subbing system for use on both the emulsion side and back side of polyester supports is a vinylidene chloride containing polymer.

Despite the above-described advantages of polyester films, there is a drawback that when used in a roll format, a persistently remaining core set curl can occur which may result in poor handling properties. An increasing trend for smaller cameras requires a reduction in the thickness of photographic imaging elements to maintain a similar number of exposures in a smaller film cartridge. Reducing the thickness of the film support has the most impact on the thickness of the photographic element. However, this results in increased demands on core set, dimensional stability and mechanical strength which require the use of polyester supports; particularly for small format films. In order to satisfy these increasing demands a polyester support comprising a poly(alkylene aromatic dicarboxylate) whose glass transition point is from 50° C. to 200° C. such as polyethylene terephtalate or polyethylene naphthalate has increasingly been used in photographic elements. Furthermore, it is well-known that heat-treatment of the polyester support at a temperature of from 40° C. up to the glass transition temperature for a period of from 0.1 hr to 1500 hrs significantly reduces the core set curl.

In addition to a polymeric support, image forming layer and adhesion promoting layers, it is well known to include in various imaging elements various auxiliary layers including antistatic layers, lubricant or transport-controlling layers, hydrophobic barrier layers, antihalation layers, abrasion and scratch protection layers, transparent magnetic recording layers and other special function layers. The inclusion and use of such transparent magnetic recording layers in light-sensitive silver halide photographic elements has been described in U.S. Pat. Nos. 3,782,947; 4,279,945; 4,302,523; 5,217,804; 5,229,259; 5,395,743; 5,413,900; 5,427,900; 5,498,512; and others. Such elements are advantageous because images can be recorded by customary photographic processes while information can be recorded simultaneously into or read from the magnetic recording layer by techniques similar to those employed for traditional magnetic recording art.

Problems associated with the generation and discharge of electrostatic charge have been recognized for many years by the photographic industry. The accumulation of charge leads to the attraction of dust, which can produce physical defects. The discharge of accumulated charge can produce irregular fog patterns or static marks in the sensitized emulsion. The presence of dust not only can result in the introduction of physical defects and the degradation of the image quality of the photographic element but also can result in the introduction of noise and the degradation of magnetic recording performance (e.g., S/N ratio, “drop-outs”, etc.) for an imaging element containing a magnetic recording layer. In order to prevent these problems arising from electrostatic charging, there are various well known methods by which an electrically-conductive or antistatic layer can be introduced into the photographic element to dissipate electrostatic charge. Typically, in photographic elements comprising a transparent magnetic recording layer, the antistatic layer is present as a backing layer underlying the magnetic recording layer.

As indicated above, it is desirable to heat-treat or anneal the polyester support to impart the required physical properties, particularly to reduce core set to an acceptable level for recent applications such as small format films for use in smaller cameras. In addition, annealing the support with subbing or backing layers is advantageous for manufacturing efficiency. Annealing of polyester supports having coated thereon an antistatic layer has been disclosed in U.S. Pat. Nos. 5,629,141; 5,582,963; 5,585,229; 5,739,309 and 5,766,835. The process taught in the above patents consists of surface treatment of the polyester support followed by application of an antistatic layer having tin oxide dispersed in gelatin. The support having an antistatic layer as a backing layer is subjected to heat treatment for the above indicated patents. After heat treatment, a subbing layer is applied on the photographic emulsion side and additional backing layers may be applied. As an additional backing layer, a protective overcoat layer consisting of cellulose diacetate and a crosslinking agent is taught in the '141, '963, '229, and '309 patents. A magnetic layer having Co-□-Fe₂O₃ and abrasive particles dispersed in cellulose diacetate which is further crosslinked is applied after heat-treatment of the support as an additional backing layer in '835. The above indicated patents also disclose that the specific heat-treatment conditions are important to control so as to avoid self-adhesion or blocking of the support. U.S. Pat. No. 5,629,141 indicates self-adhesion may occur if the winding tension or humidity are too high or the knurl height too low during heat treatment. It is further disclosed that electrification of the support accelerates self-adhesion and it is therefore desirable to include electrically-conductive particles to avoid electrification. U.S. Pat. No. 5,585,229 discloses that in addition to winding tension, temperature, and knurl height, the differences in roll diameter must be kept small to reduce the tendency for sticking or blocking during heat-treatment. It is also disclosed that heat-treatment is preferably conducted before providing a subbing layer for the photographic emulsion side since such subbing layers typically contain gelatin and therefore the layer easily adheres on heating. Examples 1-26, 2-21, and 3-26 of '229 indicate a greatly increased tendency for self-adhesion or blocking and larger regions of poor planeness for samples where the antistatic layer is annealed against a gelatin subbing layer than for similar samples prepared in which the subbing layer is applied after heat-treatment. U.S. Pat. No. 5,739,309 claims heat-treatment of the support is carried out in vacuo or in a current of an inactive gas and additionally discloses it is preferable to carry out the heat-treatment prior to application of the subbing layer.

The above indicated patents disclose heat-treatment of an antistatic layer against bare or surface treated polyester supports. Heat-treatment of a backing layer against a gelatin containing subbing layer is taught in U.S. Pat. Nos. 5,580,707; 5,597,682; and 5,719,015. A polyester support is surface treated by corona discharge treatment on both sides, followed by application of a gelatin containing subbing layer on the emulsion side. The opposite side of the support has an antistatic layer consisting of tin oxide particles dispersed in gelatin and coated out of a methanol and water mixture. The antistatic layer is then overcoated with a protective layer containing cellulose triacetate. The support having a subbing layer, antistatic layer, and protective layer is then heat-treated before application of the photographic emulsion layers. The required additional coating for the protective layer is undesirable for manufacturing efficiency.

A silver halide photographic material having a support, a silver halide emulsion layer, a magnetic recording layer and a layer containing metal oxide particles having a crystallite size, on the average, of 1 to 20 nm is claimed in U.S. Pat. No. 5,459,021. A photographic imaging element is taught in which both sides of a polyester support are surface treated by corona discharge, followed by application of subbing layers using various latex polymers consisting of butyl acrylate, styrene, and additional acrylates. The subbing layer on the emulsion side is overcoated with a gelatin subbing layer, while the subbing layer on the opposite side is coated with an antistatic layer consisting of conductive metal oxide particles dispersed in a mixture of a copolymer latex and gelatin. A magnetic layer consisting of Co-□-Fe₃O₃ dispersed in cellulose nitrate is also taught. Heat-treatment of polyethylene terephthalate or polyethylene naphthalate supports having a subbing layer and a backing layer at a temperature of 60° C. or 80° C., respectively, for 24 hrs is also indicated. The curl or core set for a film sample prepared in the above manner was evaluated by winding on a 10 mm diameter core and left for 3 days at 55° C. and 20% relative humidity. For a sample on polyethylene naphthalate which was heat-treated at 80° C. a curl removal of 60 to 70 percent was determined, somewhat improved over a similar sample which was not heat-treated and had a curl removal of 50-60 percent. The core set improvements demonstrated in '021 are advantageous for 35 mm film applications and simulate long term storage at room temperature. However, the core set results demonstrated are not sufficient for photographic elements intended for small format films in which a core diameter of less than 10 mm, typically 6-7 mm, is used in which core set requirements are more stringent. Furthermore, cellulose nitrate is not preferred as a binder for the magnetic layer due to flammability concerns which pose a significant safety risk during manufacturing.

A blend of a hydrophilic colloid and methyl cellulose is described in JP 7219122A to provide good blocking resistance when wound on a spool. Similarly, U.S. Pat. No. 4,542,093 describes a blend of gelatin and methyl cellulose coated over a subbing layer so as to prevent blocking against the subbing layer on the opposite side of the support and further, provides good adhesion when overcoated with photographic emulsion layers. However, neither annealing of the support having methyl cellulose nor adhesion of a transparent magnetic recording layer are disclosed. Furthermore, a layer which demonstrates good adhesion of photographic emulsion layers can result in poor adhesion of a transparent magnetic recording layer.

Polyurethane containing layers have been described generally as adhesion-promoting or subbing layers, antistatic layers, and abrasion resistant or protective layers for use in photographic imaging element. One specific class of polyurethanes which has been particularly useful as an outmost layer is aliphatic polyurethanes having a tensile elongation to break of at least 50 percent and a Young's modulus at a 2 percent elongation of at least 50,000. One example of such a polyurethane is Witcobond 232, commercially available from Witco Corporation, which has been taught as useful in abrasion resistant layers, protective layers and antistatic layers in U.S. Pat. Nos. 5,786,134; 5,776,668; 5,723,272; 5,709,971; 5,695,920; 5,679,505; 5,547,821 and others. An outermost layer for reduced tar stain containing a polyurethane (Witcobond 232) in combination with gelatin is taught in U.S. Pat. No. 5,786,134.

An antistatic layer having an anionic, aliphatic, polyurethane with an ultimate elongation to break of at least 350 percent as a binder is taught to have excellent adhesion to surface treated polyester supports, including polyethylene naphthalate in U.S. Pat. No. 5,718,995. It is further disclosed that the antistatic layer provides excellent adhesion to an overlying transparent magnetic recording layer. Through comparative examples U.S. Pat. No. 5,718,995 indicates inadequate adhesion for a magnetic backing package for a preferred polyurethane (Witcobond 232) of the above indicated U.S. Patents. Similarly, U.S. Pat. No. 5,726,001 discloses a polyurethane layer used to promote adhesion either overlying or underlying an antistatic layer. The use of an aliphatic, anionic polyurethane having an ultimate elongation to break of at least 350 percent as a binder for antistatic layers coated over a subbing or primer layer rather than surface treated polyester support is taught in U.S. Pat. Nos. 5,719,016 and 5,731,119. However, heat treatment above 80° C. of a polyester support having a polyurethane containing layer as the outermost layer is not disclosed in the above patents.

An object of the present invention is to provide an imaging support having as an outermost layer an antistatic layer containing electrically-conductive metal-containing particles dispersed in polymeric film forming binder which is subsequently annealed at temperatures in excess of 80° C. prior to emulsion coating without causing blocking or self-adhesion of the support. It is a further objective of the present invention that excellent adhesion of a transparent magnetic recording layer or other auxiliary layers subsequently applied to the annealed support be achieved. It is further preferred that the imaging support additionally have a gelatin subbing layer as an outermost layer opposite the antistatic layer prior to heat-treatment and that an image forming layer is superposed on the gelatin subbing layer after heat-treatment of the support.

### SUMMARY OF THE INVENTION

The present invention discloses: an imaging support comprising:

a polyester base having two sides and a glass transition temperature between 90 to 200° C.; and

an electrically conductive layer superposed on one side of the base wherein the electrically conductive layer comprises electrically conductive metal-containing fine particles dispersed in a blend of a polyurethane binder and a hydrophilic cobinder; wherein the polyurethane binder is an aliphatic, anionic polyurethane having an ultimate elongation to break of at least 350 percent; and wherein the hydrophilic cobinder is selected from the group consisting of gelatin, water soluble cellulose ethers and water soluble cellulose ether esters; wherein said support has been annealed at a temperature of about 80° C. the Tg of the polyester base for 0.1 to 1500 hours.

The non-blocking annealable support of the invention also provides good adhesion for an overlying magnetic layer. The imaging package does not require a separate protective layer overlying the antistatic layer prior to annealing nor the addition of a cross-linking agent to the magnetic layer.

### DETAILED DESCRIPTION OF THE INVENTION

The present invention is an imaging support which includes a polyester base having a glass transition temperature (T_{g}) of from 90 to 200° C., and an antistatic layer on one side of the support comprising electrically-conductive metal-containing fine particles dispersed in a film forming binder. The film forming polymeric binder consists of a mixture of an aqueous dispersible, aliphatic, anionic polyurethane binder having an ultimate elongation of at least 350 percent, and a hydrophilic cobinder selected from gelatin, and water soluble cellulose ethers or cellulose ether esters such as methyl cellulose, hydroxyethyl cellulose, hydroxymethyl cellulose, hydroxypropyl cellulose and hydroxypropylmethyl cellulose. The most preferred hydrophilic cobinders are gelatin and hydroxypropylmethyl cellulose. The imaging support having an antistatic layer as an outermost layer is heat-treated at a temperature of from 80° C. to the T_{g} of the polyester base, for 0.1 h to 1500 h. In a preferred embodiment, the imaging support is additionally coated with a gelatin-containing subbing layer on the side opposite the antistatic layer, prior to heat-treatment. After heat-treatment, the support may be coated with a transparent magnetic recording layer or other auxiliary layer superposed on the antistatic layer. The combination of the specified polyurethane and hydrophilic cobinder in the antistatic layer prevents self-adhesion or blocking during heat-treatment and most beneficially between the antistatic layer and gelatin subbing layer. Furthermore, excellent adhesion of a transparent magnetic recording layer to the annealed imaging support of the present invention is obtained.

The composite imaging support of this invention is suitable for use in various imaging elements including, for example, photographic, electrostatographic, photothermographic, migration, electrothermographic, dielectric recording, and thermal-dye-transfer imaging elements. Details with respect to the composition and function of this wide variety of imaging elements are provided in U.S. Pat. No. 5,719,016. Imaging elements that can be provided with a composite support in accordance with this invention can differ widely in structure and composition. For example, they can vary in regard to the type of support, the number and composition of the image forming layers, and the number and kinds of auxiliary layers included in the elements. The image forming layer(s) of a typical photographic imaging element includes a radiation-sensitive agent (e.g., silver halide) dispersed in a hydrophilic water-permeable colloid. Suitable hydophilic colloids include both naturally-occurring substances such as proteins, for example, gelatin, gelatin derivatives, cellulose derivatives, polysaccharides such as dextran, gum arabic, and the like; as well as synthetic polymers, for example, water-soluble polyvinyl compounds such as poly(vinylpyrrolidone), acrylamide polymers, and the like. A common example of an image-forming photographic layer is a gelatin-silver halide emulsion layer. In particular, the photographic elements can be still films, motion picture films, x-ray films, graphic arts films or microfiche. They can be black-and-white elements, color elements adapted for use in negative-positive process or color elements adapted for use in a reversal process.

Polymer film supports which are useful for the present invention have a glass transition temperature of from 90° C. to 200° C. and include polyester supports such as poly-1,4-cyclohexanedimethylene terephthalate, polyethylene 1,2-diphenoxyethane-4,4′-dicarboxylate, polybutylene terephthalate, and polyethylene naphthalate and the like; and blends or laminates thereof. Particularly preferred are polyethylene naphthalate and blends of polyethylene naphthalate with polyethylene terephthalate. Additional suitable polyester supports, polyester copolymers and polyester blends are disclosed in detail in U.S. Pat. No. 5,580,707. A laminated support may be prepared by co-extrusion, in-line lamination, or off-line lamination methods. A feedblock or a multi-manifold can be used for coextrusion of polyester supports according to the present invention. A biaxially stretched laminate support is obtained by laminating unstretched or uniaxially stretched film, and then subjecting the laminate film to additional stretching (orientation). In an off-line lamination method, biaxially stretched films are laminated by heat or various adhesives, to give a biaxially stretched laminated support. The supports can either be colorless or colored by the addition of a dye or pigment. Addition of a dye or pigment is particularly desirable for high refractive index polyester supports to reduce the tendency of light-piping or edge-fogging. An ultraviolet absorbent may also be added for anti-fluorescence. The thickness of the support is not particularly critical. Support thicknesses of 2 to 10 mils (50 μm to 254 μm) are suitable for photographic elements in accordance with this invention.

Film supports can be surface-treated on either or both sides prior to application of the gelatin subbing layer or gelatin-containing antistatic layer by various processes including corona discharge, glow discharge, atmospheric pressure glow charge, UV exposure, flame treatment, electron-beam treatment or treatment with adhesion-promoting agents including dichloroacetic acid and trichloroacetic acid, phenol derivatives such as resorcinol and p-chloro-m-cresol, solvent washing prior to overcoating with a subbing layer of the present invention. In addition to surface treatment or treatment with adhesion promoting agents, additional adhesion promoting primer or tie layers containing polymers such as vinylidene chloride-containing copolymers, butadiene-based copolymers, glycidyl acrylate or methacrylate-containing copolymers, maleic anhydride-containing copolymers, condensation polymers such as polyesters, polyamides, polyurethanes, polycarbonates, mixtures and blends thereof, and the like may be applied to the polyester support. Particularly preferred primer or tie layers comprise a chlorine containing latex or solvent coatable chlorine containing polymeric layer. Vinyl chloride and vinylidene chloride containing polymers are preferred as primer or subbing layers of the present invention. Typically the primer compositions of this invention are composed of, by weight, from about 1 to 20 parts of latex polymer solids, and from 0.1 to 5 parts by weight of an adhesion promoter such as resorcinol, chlorophenol or chloromethylphenol in an aqueous system. A stable latex polymer is prepared by emulsion polymerization as described in U.S. Pat. Nos. 2,627,088 and 3,501,301. Suitable chloride containing polymers are composed of from about 70 to 100 percent by weight of vinyl chloride monomer or vinylidene chloride monomer. Acid containing monomers are desirably included to promote adhesion of overlying layers. Additional monomers may be incorporated in the polymer to adjust the glass transition temperature. Suitable acid containing monomers include acrylic acid, methacrylic acid, itaconic acid and maleic acid. Suitable monomers for adjusting the glass transition temperature include acrylonitrile, styrene, methacrylonitrile, glycidyl acrylates and alkyl acrylates. Preferred chlorine containing polymers are composed of a mixture of (1) from about 70 to 90 percent by weight of vinylidene chloride monomer (2) of from about 0.5 to 15 weight percent of an acid containing monomer and (3) from about 5 to 30 weight percent of a T_{g} modifying monomer. Particularly preferred polymers as a subbing layer are disclosed in U.S. Pat. Appl. No. 09/106,623.

A subbing or primer composition may be applied to the polyester base using an in-line process during the base manufacture or by an off-line process. When applied in an in-line process, the layer may be coated on the polyester base prior to orientation, after orientation, or after uniaxial orientation but before biaxial orientation. The primer composition described is typically applied in accordance with U.S. Pat. Nos. 2,627,088 and 3,143,421. The coating formulation is coated onto the amorphous support material, dried, and then the resulting film is oriented by stretching and other steps applied to the film such as heat setting, as described in detail in U.S. Pat. No. 2,779,684. Accordingly, the particular support film used, the procedure and apparatus for the coating thereof and the orientation of the film are not limitations of the present invention. Any of the usual coating apparatus and processing steps employed in the art may be employed in treating the film product of the present invention.

For the imaging side of the support, a hydrophilic subbing layer containing gelatin, gelatin derivatives, a combination of gelatin and polymeric film-forming binder, or a combination of gelatin and non-film-forming polymer latex particles, and the like, is applied to the polyester film base prior to heat-treatment. The hydrophilic subbing layer may be applied to a polyester support which has been surface treated or be superposed on any suitable primer layer. A preferred subbing layer for the imaging side of the support is described in U.S. Ser. No. 09/067,306 incorporated by reference herein. When a gelatin subbing layer is employed, it is typically used in an amount of from 0.25 to 5 weight percent, preferably 0.5 to 1 weight percent. The subbing layer may include addenda such as dispersants, surface active agents, plasticizers, coalescing aids, solvents, co-binders, soluble dyes, solid particle dyes, haze reducing agents, adhesion promoting agents, hardeners, antistatic agents, matting agents, etc. For altering the coating and drying characteristics it is a common practice in the art to use surface active agents (coating aids) or to include a water miscible solvent in an aqueous dispersion. Suitable solvents include ketones such as acetone or methyl ethyl ketone, and alcohols such as ethanol, methanol, isopropanol, n-propanol, and butanol. Underlying subbing, primer or tie layers may also be surface treated, for example by corona discharge treatment, to aid wetting by the gelatin subbing formulation.

The electrically conductive antistatic layer of the present invention is typically coated opposite the imaging side of the support. The antistatic layer consists of electrically conductive metal-containing particles dispersed in a polymeric film-forming binder which consists of a mixture of an aqueous dispersible polyurethane and a hydrophilic cobinder selected from gelatin and water soluble cellulose ethers or cellulose ether esters such as methyl cellulose, hydroxyethyl cellulose, hydroxymethyl cellulose, hydroxypropyl cellulose and hydroxypropylmethyl cellulose. As demonstrated herein below through comparative examples, use of a preferred polyurethane binder without a hydrophilic cobinder results in blocking during heat treatment against a gelatin subbing layer. Use of a preferred hydrophilic polymer, without the presence of the polyurethane, results in poor adhesion of a magnetic layer, particularly without the addition of a crosslinking agent. Suitable polyurethane binders are aqueous dispersible polyurethane polymers which are aliphatic in nature, have an anionic particle charge and are characterized by an ultimate elongation prior to breaking of at least about 350 percent. Several suitable aliphatic, anionic polyurethanes for use in accordance with the invention are commercially available, from Witco Chemical Co., Greenwich, Conn., including Witcobond W-290H (ultimate elongation 600%), W-293 (725%), W-506 (550%), W-236 (450%) and W-234 (350%).

Any gelatin, gelatin derivative, or combination of gelatin with a 15 polymeric co-binder may be used for the gelatin-containing subbing layer according to a preferred embodiment and as the cobinder for the antistatic layer. Preferred gelatins include alkali-treated (i.e., lime treated), acid-treated, and enzyme-treated gelatins. The gelatin may be hardened using any of a variety of means known to one skilled in the art. Useful hardening agents include aldehyde compounds such as formaldehyde and glutaraldehyde; ketone compounds such as diacetyl and cyclopentanedione; compounds having reactive halogens such as bis(2-chloroethylurea), 2-hydroxy-4,6-dichloro-1,3,5-triazine, and those described in U.S. Pat. Nos. 3,288,775 and 2,732,303 and British Patent No. 994,869; Nmethylol compounds such as N-hydroxymethylolphthalimide and those described in U.S. Pat. Nos. 2,732,316 and 2,586,168; isocyanates described in U.S. Pat. No. 3,103,437; aziridine compounds disclosed in IJ.S. Patent Nos. 3,017,280 and 2,983,611; acid derivatives described in U.S. Pat. Nos. 2,725,294 and 2,725,295; epoxy compounds described in U.S. Pat. No. 3,091,537; halogenated carboxyaldehydes such as mucochloric acid; inorganic compounds such as chrome 30 alum, zirconium sulfate, and the carboxyl group activating compounds described in Japanese Patent Publication Nos. 56-12853, 58-32699, 60-225148. 51-126125, 5 8-50699, 52-54427 and U.S. Pat. No. 3,321,313; and the like. The gelatin containing layers may additionally serve as an acid scavenger, neutralizing HCI which may result from thermal degradation of a chlorine containing primer layer.

Suitable water soluble cellulose ethers or cellulose ether esters include methyl cellulose, hydroxyethyl cellulose, hydroxymethyl cellulose, hydroxypropyl cellulose and hydroxypropylmethyl cellulose. The most preferred hydrophilic cobinders are gelatin and hydwxypropylmethyl cellulose. Suitable methylcellulose polymers have a degree of substitution of from 0 to 2.5, preferably of from 0.5 to 2.5, and most preferably of from 1.0 to 2.5. The degree of polymerization of the methylcellulose or methylcellulose derivative can vary widely as can be selected primarily on the required viscosity for the chosen coating method. Particulary, suitable methycellulose derivatives are hydroxypropylmethyl cellulose having a degree of substitution of and a molecular weight of ______, commercially available from Dow Chemical Company under the tradenames Methocel E3, K35LV. Higher molecular weight materials such as ______ are also suitable for hopper coating methods. Additional suitable water soluble cellulose derivatives include hydoxyethyl cellulose (Natrosol 2SOLR, Hercules Chemical Company); hydroxypropyl cellulose (Klucel Type E, Hercules) and methyl cellulose (Methocel A4M, Dow Chemical).

Electrically conductive metal-containing particles which may be used in the electrically conductive antistatic layer include, e.g., conductive crystalline inorganic oxides, conductive metal antimonates, and conductive inorganic non-oxides or combinations thereof. Crystalline inorganic oxides may be chosen from ZnO, TiO₂, SnO₂, Al₂O₃, In₂O₃, SiO₂, MgO, BaO, MoO₃, WO₃, and V₂O₅ or composite oxides thereof, as described in, e.g., U.S. Pat. Nos. 4,275,103; 4,394,441; 4,416,963; 4,418,141; 4,431,764; 4,495,276; 4,571,361; 4,999,276 and 5,122,445. The use of antimony-doped tin oxide at an antimony doping level of at least 8 atom percent and having an X-ray crystallite size less than 100 Å and an average equivalent spherical diameter less than 15 nm but no less than the X-ray crystallite size as taught in U.S. Pat. No. 5,484,694 is the preferred granular conductive oxide. Conductive metal antimonates suitable for use in the antistatic layer include those as disclosed in, e.g., U.S. Pat. Nos. 5,368,995 and 5,457,013. Zinc antimonate is the preferred metal antimonate. Conductive inorganic non-oxides suitable for use as conductive particles in the antistatic layer include: TiN, TiB₂, TiC, NbB₂, WC, LaB₆, ZrB₂, MoB, and the like, as described, e.g., in Japanese Kokai No. 4/55492, published Feb. 24, 1992. The conductive particles present in the electrically conductive antistatic layer are not specifically limited in particle size or shape. The particle shape may range from roughly spherical or equiaxed particles to high aspect ratio particles such as fibers, whiskers or ribbons. In addition conductive acicular metal-containing particles as described in U.S. Pat. Nos. 5,719,016 and 5,831,119 are also preferred as antistatic agents. Additionally, the conductive materials described above may be coated on a variety of other particles, also not particularly limited in shape or composition. For example the conductive inorganic material may be coated on non-conductive SiO₂, Al₂O₃ or TiO₂ particles, whiskers or fibers.

For the preferred electrically-conductive particles of zinc antimonate and antimony-doped tin oxide, the volume percentage of conductive particles is from about 20 to 80 weight percent which corresponds to a ratio of about 60/40 to 95/5 conductive particles to binder. A suitable volume percentage of the preferred acicular conductive tin oxide particles is from about 5 to 70 volume percent, and preferably from about 10 to 50 volume percent. The electrically-conductive layer of this invention can be applied to the support at any suitable coverage depending on the specific requirements of a particular type of imaging element. For example, for silver halide photographic films, dry coating coverage is preferably in the range from about 0.01 to 2 g/m2. More preferred dry coverage is in the range of about 0.03 to 1 g/m2. The conductive layer of this invention typically exhibits a surface resistivity (20% RH, 20° C.) of less than 1×1012 ohm/square, preferably less than 1×1010 ohms/square, and more preferably, less than 1×108 ohm/square. Conductive layers of this invention underlying a transparent magnetic recording layer according to a preferred embodiment typically exhibit an internal resistivity (wet electrode resistivity) of less than 1×1011 ohm/square, preferably less than 1×109 ohm/square after overcoating with the transparent recording layer.

Coated supports in accordance with the present invention having as outermost layers a gelatin-containing subbing layer and an antistatic layer, containing gelatin and electrically-conductive particles present at between 45 and 75 volume percent, are subjected to an extended heat treatment or annealing step after conventional support film manufacturing heat treatment to reduce core-set curling tendencies of the support. Such “post manufacture” heat tempering or annealing includes heating the coated film support at a temperature in the range of from about 80° C. (more preferably about 90° C.) up to about the glass transition temperature (Tg) of the polymer support for about 0.1 to 1500 hours (more preferably 0.25 to 500 hours) as described in U.S. Pat. Nos. 4,141,735 and 5,326,689 (describes wider temp range), incorporated herein by reference. The heat tempering or annealing step for reducing core-set curling tendencies is distinguishable from typical support manufacturing heat treatment in that it is performed after the support is wound on a roll rather than as part of the primary support manufacturing process. In a preferred embodiment of the present invention, the imaging support consists of a polyethylene-2,6-naphthalate film base which is coated on both sides with vinylidene chloride primer layers. A gelatin subbing layer is applied on one side of the support and an aqueous antistatic coating composition having tin oxide or zinc antimonate particles dispersed in gelatin is coated on the opposite side of the support. The support is annealed at a temperature from about from 90° C. to 4° C. below the T_{g} of the polyester base for between 0.25 and 500 hours. With respect to polyethylene-2,6-naphthalate, the Tg is about 140 deg. C., and the heat treatment temperature is from 90 deg. C. to 120 deg. C., preferably from 100 deg. C. to 115 deg. C., and more preferably from 105 deg. C. to 115 deg. C.

As indicated in the prior art, the winding tension, winding speed, knurl height, humidity, roll diameter, roll uniformity, core material, and core diameter are also important considerations during the heat treatment process. A preferred winding tension is from 3 to 75 kg/m, more preferably from 5 to 40 kg/m, and most preferably from 10 to 35 kg/m. When the winding tension is too high, self-adhesion of the support may occur, particularly for a gelatin subbing on the imaging side and a gelatin containing antistatic layer having between 45 and about 55 volume percent conductive particles. On the other hand, when the tension is less than 3 kg/m, slippage may occur which results in poor handling characteristics. The winding may be conducted at a constant tension, or while gradually increasing or decreasing the tension. A preferred method is to conduct the winding while decreasing the tension. The winding procedure may be conducted at any temperature ranging from room temperature to the Tg of the support. It is preferred to wind the support at a temperature of greater than 80° C. to reduce the time required at elevated temperature to achieve the appropriate core set reduction while in the rolled format. It is generally preferred to control the humidity during the heat-treatment. The preferred relative humidity is from 0% to 85%, more preferably from 0% to 80%, and most preferably from 0% to 75%.

After heat-treatment of the support, the antistatic layer of the present invention may optionally be overcoated with a wide variety of additional functional or auxiliary layers such as a transparent magnetic recording layer, abrasion resistant layers, protective layers, curl control layers, transport control layers, lubricant layers, image recording layers, adhesion promoting layers, layers to control water or solvent permeability. In preferred embodiments of the invention, the imaging element further comprises a transparent magnetic recording layer superposed on the antistatic layer, and an image forming layer comprising a silver halide emulsion layer is superposed on the gelatin subbing layer after heat-treatment of the support.

Transparent magnetic layers suitable for use in the composite supports and imaging elements in accordance with the invention include those as described, e.g., in Research Disclosure, November 1992, Item 34390. Research Disclosure is published by Kenneth Mason Publications, Ltd., Dudley House, 12 North Street, Emsworth, Hampshire P010 7DQ, ENGLAND. The magnetic layer may contain optional additional components for improved manufacturing or performance such as crosslinking agents or hardeners, catalysts, coating aids, dispersants, surfactants, including fluorinated surfactants, charge control agents, lubricants, abrasive particles, filler particles and the like. The magnetic particles of the present invention can comprise ferromagnetic or ferromagnetic oxides, complex oxides including other metals, metallic alloy particles with protective coatings, ferrites, hexaferrites, etc. and can exhibit a variety of particulate shapes, sizes, and aspect ratios. Ferromagnetic oxides useful for transparent magnetic coatings include γ-Fe₂O₃, Fe₃O₄, and CrO₂. The magnetic particles optionally can be in solid solution with other metals and/or contain a variety of dopants and can be overcoated with a shell of particulate or polymeric materials. Preferred additional metals as dopants, solid solution components or overcoats are Co and Zn for iron oxides; and Li, Na, Sn, Pb, Fe, Co, Ni, and Zn for chromium dioxide. Surface-treatments of the magnetic particle can be used to aid in chemical stability or to improve dispersibility as is commonly practiced in conventional magnetic recording. Additionally, magnetic oxide particles may contain a thicker layer of a lower refractive index oxide or other material having a low optical scattering cross-section as taught in U.S. Pat. Nos. 5,217,804 and 5,252,441. Cobalt surface-treated γ-iron oxide is a preferred magnetic particle. Ferromagnetic particles of this type are available commercially, for example, from Toda Kogyo Corp. under the tradenames CSF 4085V2, CSF 4565V, CSF 4585V, and CND 865V, and also from ISK Magnetics, Inc. under the tradenames RPX4392, RPX-5003, RPX-5026, and RPX-5012.

Suitable polymeric binders for the transparent magnetic recording layer, antistatic layer, or auxiliary layers coated over the subbing layer of the present invention include: gelatin; cellulose compounds such as cellulose nitrate, cellulose acetate, cellulose diacetate, cellulose triacetate, carboxymethyl cellulose, hydroxyethyl cellulose, cellulose acetate butyrate, cellulose acetate propionate, cellulose acetate phthalate and the like; vinyl chloride or vinylidene chloride-based copolymers such as, vinyl chloride-vinyl acetate copolymers, vinyl chloride-vinyl acetate-vinyl alcohol copolymers, vinyl chloride-vinyl acetate-maleic acid copolymers, vinyl chloride-vinylidene chloride copolymers, vinyl chloride-acrylonitrile copolymers, acrylic ester-vinylidene chloride copolymers, methacrylic ester-vinylidene chloride copolymers, vinylidene chloride-acrylonitrile copolymers, acrylic ester-acrylonitrile copolymers, methacrylic ester-styrene copolymers, thermoplastic polyurethane resins, thermosetting polyurethane resins, phenoxy resins, phenolic resins, epoxy resins, polycarbonate or polyester resins, urea resins, melamine resins, alkyl resins, urea-formaldehyde resins, and the like; polyvinyl fluoride, butadiene-acrylonitrile copolymers, acrylonitrile-butadiene-acrylic acid copolymers, acrylonitrile-butadiene-methacrylic acid copolymers, polyvinyl alcohol, polyvinyl butyral, polyvinyl acetal, styrene-butadiene copolymers, acrylic acid copolymers, polyacrylamide, their derivatives and partially hydrolyzed products; and other synthetic resins. Other suitable binders include aqueous emulsions of addition-type polymers and interpolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins and aqueous dispersions of polyurethanes or polyesterionomers. Preferred binders for the transparent magnetic recording layer include polyurethanes, polyesters, vinyl chloride based copolymers, and cellulose esters, particularly cellulose diacetate and cellulose triacetate. Cellulose diacetate is the most commonly used polymeric binder for a transparent magnetic recording layer for application in a small format photographic imaging element and is frequently crosslinked by any suitable crosslinking or hardening agent, though crosslinking is not required according the present invention. The binder in the magnetic recording layer can be optionally crosslinked. Binders which contain active hydrogen atoms including —OH, —NT-12, —NHR, where R is an organic radical, and the like, can be crosslinked using an isocyanate or polyisocyanate as described in U.S. Pat. No. 3,479,310. Suitable polyisocyanates include: tetramethylene diisocyanate, hexamethylenc diisocyanate, diisocyanato dimethylcyclohexane, dicyclohcxylmethane diisocyanate, isophorone diisocyariate, dimethylbenzene diisocyanate, methylcyclohexylene diisocyanate, lysine diisocyanate, tolylene diisocyanate, diphenylmethane diisocyanate, and polymers thereof˜polyisocyanates prepared by reacting an excess of an organic diisocyariate with an active hydrogen-containing compounds such as polyols, polyethers and polyesters and the like, including ethylene glycol, propylene glycol, dipropylene glycol, butylene glycol, trimethylol propane, hexanetriol, glycerine sorbitol, pentaerythritol, castor oil, ethylenediamine, hexamethylcncdiamine, ethanolamine, diethanolamine, 15 triethanolamine, water, ammonia, urea, and the like, including biuret compounds, allophanate compounds, and the like.

Photographic elements in accordance with the preferred embodiment of the invention can be single color elements or multicolor elements. Multicolor elements contain image dye-forming units sensitive to each of the three primary regions of the spectrum. Each unit can comprise a single emulsion layer or multiple emulsion layers sensitive to a given region of the spectrum. The layers of the element, including the layers of the image-forming units, can be arranged in various orders as known in the art. In an alternative format, the emulsions sensitive to each of the three primary regions of the spectrum can be disposed as a single segmented layer.

A typical multicolor photographic element comprises a support bearing a cyan dye image-forming unit comprised of at least one red-sensitive silver halide emulsion layer having associated therewith at least one cyan dye-forming coupler, a magenta dye image-forming unit comprising at least one green-sensitive silver halide emulsion layer having associated therewith at least one magenta dye-forming coupler, and a yellow dye image-forming unit comprising at least one blue-sensitive silver halide emulsion layer having associated therewith at least one yellow dye-forming coupler. The element can contain additional layers, such as filter layers, interlayers, antihalation layers, overcoat layers, subbing layers, and the like.

Photographic elements in accordance with one embodiment of the invention are preferably used in conjunction with an applied magnetic layer as described in Research Disclosure, November 1992, Item 34390. It is also specifically contemplated to use composite supports according to the invention in combination with technology useful in small format film as described in Research Disclosure, June 1994, Item 36230. Research Disclosure is published by Kenneth Mason Publications, Ltd., Dudley House, 12 North Street, Emsworth, Hampshire P010 7DQ, ENGLAND.

In the following discussion of suitable materials for use in the photographic emulsions and elements that can be used in conjunction with the composite supports of the invention, reference will be made to Research Disclosure, September 1994, Item 36544, available as described above, which will be identified hereafter by the term “Research Disclosure.” The Sections hereafter referred to are Sections of the Research Disclosure, Item 36544.

The silver halide emulsions employed in the image-forming layers of photographic elements can be either negative-working or positive-working. Suitable emulsions and their preparation as well as methods of chemical and spectral sensitization are described in Sections I, and III-IV. Vehicles and vehicle related addenda are described in Section II. Dye image formers and modifiers are described in Section X. Various additives such as UV dyes, brighteners, luminescent dyes, antifoggants, stabilizers, light absorbing and scattering materials, coating aids, plasticizers, lubricants, antistats and matting agents are described, for example, in Sections VI-IX. Layers and layer arrangements, color negative and color positive features, scan facilitating features, supports, exposure and processing can be found in Sections XI-XX.

In addition to silver halide emulsion image-forming layers, the image-forming layer of imaging elements in accordance with the invention may comprise, e.g., any of the other image forming layers described in. U.S. Pat. 5,457,013, the disclosure of which is incorporated by reference herein.

The method of the present invention is illustrated by the following detailed examples of its practice. However, the scope of this invention is by no means limited to these illustrative examples.

### EXAMPLES

### Comparative Example 1

A thick sheet of polyethylene naphthalate (PEN) was melt extruded, and a vinylidene chloride containing adhesion promoting or primer layer was applied to both sides of the support. The support was then stretched and tentered forming a 102 micron thick PEN film with approximately 60 nm thick primer layer. A gelatin subbing was applied over the primer layer on one side of the support to give a nominal dry coverage approximately 0.09 gIm². On the side opposite the gelatin subbing layer an antistat layer, having colloidal vanadium pentoxide dispersed in a terpolymer latex, was coated to give a nominal total dry coverage of 0.015 g/m². A polyurethane layer was coated on top of the antistatic layer from water to give a final dry coverage of 0.22 gfm². The polyurethane used was Witcobond W236, commercially available from Witco Corp. The coated support having as outermost layers a gelatin subbing layer and a polyurethane layer was wound onto a 6 inch core and placed in an oven for 3 days at 100° C. The sample blocked during annealing and was not suitable for subsequent 25 coatings.

### Comparative Example 2

An antistatic layer having zinc antimonate conductive particles dispersed in a preferred aliphatic, anionic polyurethane binder but without a hydrophilic cobinder was applied to surface treated polyethylene naphthalate in a similar manner to examples described in U.S. Pat. No. 5,718,995. The support was treated on both sides using nitrogen glow discharge treatment. An antistatic coating composition according to the formulation given below was applied to give a nominal total dry coverage of 0.60 g/m².

| Component | Weight % (wet) |
|---|---|
| Colloidal zinc antinonate¹ | 4.154 |
| Polyurethane binder² | 0.461 |
| Wetting aid³ | 0.033 |
| Water | 95.382 |

¹Celnax CX-Z, Nissan Chemical America, Inc.
²Witcobond W236, Witco Corp
³Triton X-100, Rohm & Haas

The support having an antistatic layer was knurled and annealed at conditions to give 100° C. for 48 hrs throughout the roll. No blocking was noted for the support. After annealing the support, a transparent magnetic recording layer was coated over the antistatic layer having the following formulation. A lubricant layer having nominally 0.02 g/m² of carnuaba wax was applied to the magnetic recording layer.

| | | |
|---|---|---|
| Cellulose diacetate | 2.51 | g |
| Cellulose triacetate | 0.115 | g |
| Magnetic oxide Toda CSF-4085V2 | 0.113 | g |
| Surfactant Rhodafac PES 10 | 0.006 | g |
| Alumina Norton E-600 | 0.076 | g |
| Dispersing aid, Zeneca Solsperse 24000 | 0.004 | g |
| 3MFC431 | 0.015 | g |
| Dichloromethane | 67.919 | g |
| Acetone | 24.257 | g |
| Methyl acetoacetate | 4.851 | g |

The magnetic backing packages prepared in accordance with this invention and the comparative examples were evaluated for antistatic layer performance, dry adhesion and wet adhesion. Antistatic performance was evaluated by measuring the internal electrical resistivity using a salt bridge wet electrode resistivity (WER) measurement technique (as described, for example, in “Resistivity Measurements on Buried Conductive Layers” by R. A. Elder, pages 251-254, 1991) EOS/ESD Symposium Proceedings). Typically, antistatic layers with WER values greater than about 1×10¹² ohm/square are considered to be ineffective at providing static protection for photographic imaging elements, less than 1×10¹¹ ohm/square are preferred, and less than 1×10¹⁰ ohm/square more preferred.

Dry adhesion of the magnetic backing package was evaluated by scribing a small region of the coating with a razor blade. A piece of high-tack adhesive tape was placed over the scribed region and quickly removed multiple times. The number of times the adhesive tape could be removed without any coating removal is a qualitative measure of the dry adhesion. Dry adhesion was evaluated both before and after photographic processing by the standard C-41 process. Wet adhesion was evaluated using a procedure which simulates wet processing of silver halide photographic elements. A one millimeter wide line was scribed into a sample of the magnetic backings package. The sample was then immersed in KODAK Flexicolor developer solution at 38° C. and allowed to soak for 3 minutes and 15 seconds. The test sample was removed from the heated developer solution and then immersed in another bath containing Flexicolor developer at about 25° C. and a rubber pad (approximately 3.5 cm dia.) loaded with a 900 g weight was rubbed vigorously back and forth across the sample in the direction perpendicular to the scribe line. The relative amount of additional material removed is a qualitative measure of the wet adhesion of the various layers. WER values and adhesion results arc given in Table 1.

### Comparative Example 3

A 90 mm poly(ethylene naphthalate) east sheet was coated on both sides of the support with a terpolymer latex consisting of vinylidene chloride, acrylonitrile and acrylic acid. The following coating formulation was used to obtain a dry coverage of approximately 11 mg/dm²:

| Material | Dry Coverage (mg/dm²) | Weight % (wet) |
|---|---|---|
| terpolymer | 10 | 7.0 |
| 1,3-dihydroxybenzene | 1.0 | 1.0 |
| saponin | 0.1 | 0.1 |
| water | 0.1 | 91.9 |

The support was stretched approximately four times in the machine direction and four times in the transverse direction. A gelatin-containing subbing layer was subsequently coated over the terpolymer subbing layer on the imaging side of the support to obtain a dry coverage of approximately 1 mg/dm² gelatin. The gelatin subbing layer formulation is given below:

| Material | Dry Coverage (mg/dm²) | Weight % (wet) |
|---|---|---|
| gelatin | 1.0 | 0.50 |
| saponin | 0.02 | 0.01 |
| water | — | 99.49 |

The support was then dried at 110° C. and heat relaxed at about 140° C.

The subbed support was coated with the antistatic coating composition of Comparative Example 2 to give a nominal total dry coverage of 0.60 g/m². The support having coated thereon vinylidene chloride primer layers on both sides, a gelatin containing subbing layer on the emulsion side, and an antistatic layer on the opposite side from the gelatin subbing layer was annealed in a similar manner to Comparative Example 2.

The annealed support had a transparent magnetic recording layer applied in a similar manner to Comparative Example 2, however the coating formulation also contained 5 weight percent based on the weight of cellulose diacetate of a melamine-formaldehyde resin as a crosslinking agent, Cymel 303 (Cytec md.) and 3 weight percent based on the weight of the crosslinking agent of paratoluene sulfonic acid (PTSA). The magnetic recording layer was overcoated with a carnauba wax lubricant layer and the gelatin subbing layer was overcoated with photographic emulsion layers according to Comparative Example 2. WER values and adhesion results are given in Table 1.

### Comparative Examples 4a and 4b

A coated support was prepared in a similar manner to Comparative Example 1, except the polyurethane layer was replaced with a hydroypropyl methyl cellulose (E3 Premium, Dow Chemical Co.) layer at a nominal total dry coverage of 0.22 g/m². The coated support having as outermost layers a gelatin subbing layer and a hydroypropyl methyl cellulose layer was wound onto a 6 inch core and placed in an oven and annealed for 3 days at 100° C. No blocking of the support was noted. The support was subsequently overcoated with a transparent magnetic recording layer and a carnauba wax lubricant layer. Comparative Example 4a had the magnetic layer composition of Comparative Example 2 applied and Comparative Example 4b had the crosslinked magnetic recording layer described for Comparative Example 3 applied. WER values and adhesion results are given in Table I.

### Comparative Example 5

A coated support was prepared in a similar manner to Comparative Example 1, except the polyurethane layer was replaced with a gelatin layer at a nominal total dry coverage of 022 g/m². The coated support having gelatin as outermost was wound onto a 6 inch core and placed in an oven and annealed for 3 days at 100° C. The support experienced partial blocking and was not suited to subsequent coatings.

### Example 1

A 90 mm poly(ethylene naphthalate) cast sheet was coated on both sides of the support with a terpolymer latex consisting of vinylidene chloride, acrylonitrile and acrylic acid. The following coating formulation was used to obtain a dry coverage of approximately 11 mg/dm²:

| Material | Dry Coverage (mg/dm²) | Weight % (wet) |
|---|---|---|
| terpolymer | 10 | 7.0 |
| 1,3-dihydroxybenzene | 1.0 | 1.0 |
| saponin | 0.1 | 0.1 |
| water | — | 91.9 |

The support was stretched approximately four times in the machine direction and four times in the transverse direction. A gelatin-containing subbing layer was subsequently coated over the terpolymer subbing layer on the imaging side of the support to obtain a dry coverage of approximately 1 mg/dm² gelatin. The gelatin subbing layer formulation is given below:

| Material | Dry Coverage (mg/dm²) | Weight % (wet) |
|---|---|---|
| gelatin | 1.0 | 0.50 |
| saponin | 0.02 | 0.01 |
| water | — | 99.49 |

The support was then dried at 110° C. and heat relaxed at about 140° C.

An aqueous antistatic coating formulation containing colloidal conductive zinc antimonate particles dispersed in a mixture of a polyurethane and hydrophulic cobinder was prepared at nominally 4.6 percent solids by weight. The coating formulation is given below. The weight ratio of colloidal zinc antimonate to total binder was nominally 90/10. The polyurethane binder used in the present Example was W236 and the hydrophilic polymer was a hydroxypropylmethyl cellulose. The support having coated thereon vinylidene chloride primer layers on both sides, a gelatin containing subbing layer on the emulsion side, and an antistatic layer on the opposite side from the gelatin subbing layer was annealed in a similar manner to Comparative Example 2.

| Component | Weight % (wet) |
|---|---|
| Colloidal zinc antimonate¹ | 4.154 |
| Polyurethane binder² | 0.231 |
| Hydrophilic co-binder³ | 0.231 |
| Wetting aid⁴ | 0.033 |
| Water | 95.381 |

¹Celnax CX-Z, Nissan Chemical America, Inc.
²Witcobond W236, Witco Corp.
³E3 Premium, Dow Chemical Co.
⁴Triton X-100, Rohm & Haas

The annealed support had a transparent magnetic recording layer applied in a similar manner to Comparative Example 2, however the coating formulation also contained 10 weight percent based on the weight of cellulose diaectate of a crosslinking agent, Cymel 303 (Cytec md.) and 3 weight percent based on the weight of crosslinking agent of PTSA. The magnetic recording layer was overcoated with a carnauba wax lubricant layer and the gelatin subbing layer overcoated with photographic emulsion layers according to Comparative Example 2. WER values and adhesion results are given in Table 1.

### Example 2

An annealed support having a gelatin subbing layer and an antistatic layer was prepared in a similar manner as Example I except for the composition of the antistatic layer which is given below. The annealed support was additionally coated with a crosslinked magnetic recording layer. In the present example, the hydrophilic cobinder was gelatin.

| Component | Weight % (wet) |
|---|---|
| Colloidal zinc antimonate¹ | 4.154 |
| Polyurethane binder² | 0.116 |
| Gelatin | 0.346 |
| Wetting aid³ | 0.033 |
| Water | 95.351 |

¹Celnax CX-Z, Nissan Chemical America, Inc.
²Witcobond W236, Witco Corp.
³Triton X-100. Rohm & Haas

### Example 3

An annealed support having an antistatic layer containing zinc antimonate, a polyurethane binder and a hydrophilic cobinder was prepared as in Example 1. In the present example, the annealed support was overcoated with a transparent magnetic recording layer having Co-γ-Fe,0₃ particles dispersed in a methylmethacrylate-methacrylie acid eobinder rather than cellulose diacetate.

### Example 4

An annealed support having an antistatic layer containing zinc antimonate, a polyurethane binder and a hydrophilic cobinder was prepared as in Example 2. In the present example, the annealed support was overcoated with a transparent magnetic recording layer having Co-γ-Fe₂0₃ particles dispersed in a methylmethacrylate-methacrylic acid cobinder rather than cellulose diacetate.

### Example 5

An annealed support having an antistatic layer containing zinc anitimonate, a polyurethane binder and a hydrophilic cobinder was prepared as in Example 2. In the present example, the annealed support was overcoated with a transparent magnetic recording layer having Co-γ-Fe₂0₃, particles dispersed in cellulose triacetate rather than cellulose diacetate and no crosslinking agent was used.

Comparative Example 1 demonstrates that a polyurethane layer without the presence of electrically-conductive particles or a hydrophilic cobinder results in blocking or self-adhesion when annealed against a gelatin subbing layer. Addition of electrically-conductive zinc antimonate particles results in a non-blocking annealable support as demonstrated by Comparative Examples 2 and 3, however, it remains difficult to achieve adequate adhesion, particularly dry adhesion after photographic processing, of a cellulose acetate based magnetic recording layer. A gelatin containing layer coated over an antistatic layer also resulted in blocking during annealing as anticipated based on prior art disclosures for a gelatin containing antistatic layer. However, the combination of electrically-conductive particles, an aliphatic, anionic polyurethane having an ultimate elongation to break of at least 350 percent and a hydrophilic cobinder provides an antistatic layer which can be annealed against a gelatin subbing layer without blocking and furthermore, provides excellent adhesion for an overlying transparent. Most notably, excellent dry adhesion after photographic processing is obtained for the present invention.

| | Wet | | Dry Adhesion | WER |
|---|---|---|---|---|
| Example | Adhesion | Dry Adhesion | post-C41 | log Ω/sq |
| Comp 2 | 23 (poor) | poor | poor | 7.1 |
| Comp 3 | 0 | excellent | poor | 6.9 |
| Comp 4a | * | poor | * | * |
| Comp 4b | * | very poor | * | * |
| Example 1 | 0 | excellent | excellent | 8.2 |
| Example 2 | 0 | excellent | excellent | 7.9 |
| Example 3 | 0 | excellent | excellent | 8.2 |
| Example 4 | 0 | excellent | excellent | 8.0 |
| Example 5 | 12.5 (fair) | excellent | fair | 7.6 |

This invention has been described in detail with particular reference to preferred embodiments thereof, but it will be understood that variations and modifications can be effected within the spirit and scope of the invention.

What is claimed is:

1. An imaging support comprising:
a polyester base having two sides; and
an electrically conductive layer superposed on one side of the base wherein the electrically conductive layer comprises electrically conductive metal-containing fine particles dispersed in a blend of a polyurethane binder and a hydrophilic cobinder; wherein the polyurethane binder is an aliphatic, anionic polyurethane having an ultimate elongation to break of at least 350 percent.

2. The imaging support of claim 1 wherein the polyester base has a glass transition temperature between 90 to 200° C.

3. The imaging support of claim 1 wherein the hydrophilic cobinder is selected from the group consisting of gelatin, water soluble cellulose ethers and water soluble cellulose ether esters.

4. The imaging support of claim 1 wherein the support is annealed at a temperature of from 80° C. to the T_{g} of the polyester base, for 0.1 h to 1500 h.
